(19) United States
(12) Patent Application Publication
(10) Pub. No.: US 2026/0289464 A1
(43) Pub. Date: Sep. 24, 2026

(54) METHODS, SYSTEMS, AND COMPUTER-READABLE MEDIA FOR DETERMINING AN OVERALL RISK ASSOCIATED WITH A COMMUNICATION

(71) Applicant: Royal Bank of Canada, Toronto (CA)

(72) Inventors: Fatima Hussain, Toronto (CA); Moussa Noun, Halifax (CA); Mandil Karki, Vancouver (CA); Mukesh Reddy Kayadapuram, Toronto (CA); Dhanya Jothimani, Toronto (CA)

(21) Appl. No.: 19/577,048

(22) Filed: Mar. 24, 2026

Related U.S. Application Data
(60) Provisional application No. 63/776,598, filed on Mar. 24, 2025.

(51) Int. Cl. G06Q 10/0635; G06Q 30/018

(52) U.S. Cl. CPC G06Q 10/0635; G06Q 30/0185

(57) ABSTRACT

A method of determining an overall risk associated with a communication is provided. One or more processors perform a first risk analysis by analyzing metadata associated with the communication and, based on the analyzed metadata, determining a risk profile of the communication. A second risk analysis is performed by comparing the risk profile to one or more stored risk profiles. Based on the comparison, it is determined whether a third risk analysis is required. If required, the third risk analysis is performed by analyzing content of the communication to determine the overall risk associated with the communication. The staged approach reduces computational resource usage by selectively performing content analysis only for communications that warrant further evaluation.

### FIELD

The present disclosure relates to threat detection and in particular to methods, systems, and computer-readable media for determining an overall risk associated with a communication.

### BACKGROUND

Insider threat detection systems have traditionally relied on technical monitoring controls, workplace behavioral indicators, evidentiary reconstruction of user actions, and post-incident analytical decision-making. These approaches seek to correlate user activity data with organizational context to assess potential threats.

Correlation of incident-related information across heterogeneous organizational domains, including human resources systems, information technology infrastructure, and security monitoring platforms, presents technical challenges. Data sources are often siloed, structurally inconsistent, and require manual interpretation to generate contextual assessments.

Natural language processing (NLP) techniques have been applied to insider threat detection to analyze human-generated texts, including analyst reports and historical incident narratives. Existing NLP-based systems are primarily trained on past incident descriptions and analyst-authored documentation. Such systems depend on manually curated narratives to provide contextual information and domain-specific interpretation.

However, these approaches require substantial manual effort, domain expertise, and subjective interpretation. Model outputs may reflect analyst bias, narrative framing effects, or recurring patterns present in the training corpus.

### SUMMARY

According to a first aspect of the disclosure, there is provided a method of determining an overall risk associated with a communication, comprising using one or more processors to: perform a first risk analysis, comprising: analyzing metadata associated with the communication; and based on the analyzed metadata, determining a risk profile of the communication; perform a second risk analysis, comprising: comparing the risk profile to one or more stored risk profiles; and based on the comparison, determining that a third risk analysis is required; and perform the third risk analysis, comprising: analyzing a content of the communication to determine the overall risk associated with the communication.

Analyzing the metadata may comprise analyzing a domain associated with the communication. Determining the risk profile of the communication may be based on the analyzed domain.

Analyzing the metadata may comprise analyzing a signature associated with the communication. Determining the risk profile of the communication may be based on the analyzed signature.

Analyzing the metadata may comprise analyzing one or both of a subject and a body of the communication. Determining the risk profile of the communication may be based on one or both of the analyzed subject and the analyzed body.

Analyzing the metadata may comprise: identifying, based on the metadata, a sender of the communication and an intended recipient of the communication; and analyzing a relationship between the sender and the intended recipient. Determining the risk profile of the communication may be based on the analyzed relationship.

Analyzing the metadata may comprise: analyzing a domain associated with the communication; analyzing a signature associated with the communication; analyzing one or both of a subject and a body of the communication; identifying, based on the metadata, a sender of the communication and an intended recipient of the communication; and analyzing a relationship between the sender and the intended recipient. Determining the risk profile of the communication may be based on the analyzed domain, the analyzed signature, one or both of the analyzed subject and the analyzed body, and the analyzed relationship.

The one or more stored risk profiles may be associated with one or more high-risk communications.

Comparing the risk profile to the one or more stored risk profiles may comprise: converting the risk profile into one or more feature vectors; and comparing the one or more feature vectors to one or more stored feature vectors associated with the one or more stored risk profiles.

Analyzing the content may comprise: inputting the content to a trained machine learning model; and using the trained machine learning model to generate, based on the inputted content, an indication of the overall risk associated with the communication.

Inputting the content may comprise: selecting, based on the communication, the trained machine learning model from a pool of trained machine learning models; and inputting the content to the selected trained machine learning model.

Selecting the trained machine learning model may comprise: selecting the trained machine learning model based on one or both of an identified risk and one or more attachments associated with the communication.

Analyzing the content may further comprise: further inputting one or more prompts to the trained machine learning model; and using the trained machine learning model to generate, based on the inputted content and the one or more prompts, an indication of the overall risk associated with the communication.

Inputting the one or more prompts may comprise: selecting, based on the communication, the one or more prompts from a pool of prompts; and inputting the selected one or more prompts to the trained machine learning model.

Selecting the one or more prompts may comprise: selecting the one or more prompts based on one or both of an identified risk and one or more attachments associated with the communication.

The trained machine learning model may be a trained small language machine learning model.

The method may further comprise comparing the overall risk to a predetermined threshold. Based on the comparison, the method may further comprise adjusting one or both of: a pool of prompts for use with the trained machine learning mode; and a pool of trained machine learning models for performing content analysis of communications.

The method may further comprise: determining, based on the overall risk, that the communication is a high-risk communication; and preventing the high-risk communication from being transmitted.

According to a further aspect of the disclosure, there is provided a method of determining an overall risk associated with a communication, comprising using one or more processors to: perform a first risk analysis, comprising: analyzing metadata associated with the communication; and based on the analyzed metadata, determining that second risk analysis is required; and performing the second risk analysis, comprising: inputting a content of the communication to a trained machine learning model; and using the trained machine learning model to generate, based on the inputted content, an indication of the overall risk associated with the communication.

According to a further aspect of the disclosure, there is provided a non-transitory, computer-readable medium storing computer program code configured, when executed by one or more processors, to cause the one or more processors to perform any of the methods described herein.

This summary does not necessarily describe the entire scope of all aspects. Other aspects, features, and advantages will be apparent to those of ordinary skill in the art upon review of the following description of specific embodiments.

### BRIEF DESCRIPTION OF THE DRAWINGS

Embodiments of the disclosure will now be described in detail in conjunction with the accompanying drawings of which:

FIG. 1 is a schematic diagram of multiple risk analysis layers used in a process of sequentially analyzing metadata and contents of a communication, according to an embodiment of the disclosure;

FIG. 2 is a schematic diagram of a system for determining an overall risk associated with a communication, according to an embodiment of the disclosure;

FIG. 3 is a schematic diagram of a method of determining an overall risk associated with a communication, according to an embodiment of the disclosure; and

FIG. 4 is a schematic diagram of an example computer system that may be used to train any of the machine learning models described herein, and that may be used to perform any of the computer-implemented methods described herein, according to an embodiment of the disclosure.

### DETAILED DESCRIPTION

The present disclosure seeks to provide novel methods, systems, and computer-readable media for determining an overall risk associated with a communication. While various embodiments of the disclosure are described below, the disclosure is not limited to these embodiments, and variations of these embodiments may well fall within the scope of the disclosure which is to be limited only by the appended claims.

According to some embodiments of the disclosure, a layered risk analysis architecture is provided in which risk assessment is performed in stages of increasing computational cost.

For example, in a first stage, a preliminary risk score associated with a communication may be determined based on metadata associated with the communication. Metadata may include, for example, sender information, recipient information, timing data, or other contextual attributes.

Communications exceeding a predetermined risk threshold may then be subjected to a second-stage analysis involving content-based evaluation of the communication. The content-based evaluation may employ natural language processing (NLP) techniques to assess semantic or contextual risk indicators.

According to some embodiments, a reinforcement learning (RL) engine is used to select one or more prompts and one or more trained language models (such as small language models (SLMs)) for use in content analysis based on a given context associated with a communication. Different prompts may yield different outputs depending on the contextual characteristics of the communication, and therefore prompt selection may influence the accuracy and reliability of the analysis.

In some embodiments, the RL engine implements a sequential or chained decision-making process in which multiple prompts and/or multiple SLMs are evaluated in combination to generate a prediction. The RL engine may determine an ordered sequence of prompts and corresponding SLMs to be applied, thereby forming a decision chain that improves prediction quality.

During operation, multiple prompt-SLM combinations may be applied to analyze a communication and generate one or more predicted risk outcomes. When ground truth becomes available (for example, where a communication is subsequently confirmed to be a true incident), the RL engine updates its selection policy based on the observed outcome and the prompt-SLM combinations that were used. In this manner, the RL engine learns to associate particular prompts and models with improved predictive performance in specific contexts. Over time, through iterative feedback and policy updates, the RL engine converges toward selecting prompts and SLMs that provide increased accuracy and precision for different types of communications and associated risk conditions.

According to embodiments of the disclosure, there is described a method of determining an overall risk associated with a communication. One or more computer processors are used to perform a first risk analysis which includes analyzing metadata associated with the communication, and, based on the analyzed metadata, determining a risk profile of the communication. A second risk analysis is then performed in which the risk profile is compared to one or more stored risk profiles. Based on the comparison, a determination can be made as to whether or not further risk analysis is required. If further risk analysis is determined to be required, a third risk analysis is performed in which a content of the communication is analyzed to determine the overall risk associated with the communication. If, following the content analysis, the communication is determined to be high-risk, its transmission may be blocked, and/or other action can be taken (such as a warning being displayed to the sender). In this context, “high-risk” should be interpreted as meaning that the determined risk exceeds a pre-defined threshold.

By performing content analysis conditionally based on the outcome of metadata analysis, risk prediction accuracy may be improved while reducing computational cost, since content analysis need not be performed for all outgoing communications. Additionally, by comparing the risk profile of a communication to stored risk profiles, such as profiles of previously identified high-risk communications, the determination of whether to initiate computationally expensive content analysis may be made more reliably. Further, increasing the positive identification rate of malicious or risky communications may reduce the time, resources, and costs associated with investigation and remediation.

In some embodiments, an overall risk associated with a communication is determined using a two-stage process. One or more processors first perform a metadata-based risk analysis by analyzing metadata associated with the communication, such as sender information, recipient information, domain information, transmission patterns, or attachment indicators. Based on the analyzed metadata, the processors determine whether further analysis is required. If it is determined that a second risk analysis is required, content of the communication, including any attachments, is input to one or more trained machine learning model. The trained machine learning models, which may comprise small language models (SLM) or other trained neural network models, process the content and generate an indication of the overall risk associated with the communication. The generated indication may comprise a risk score, classification label, probability value, or other structured risk representation.

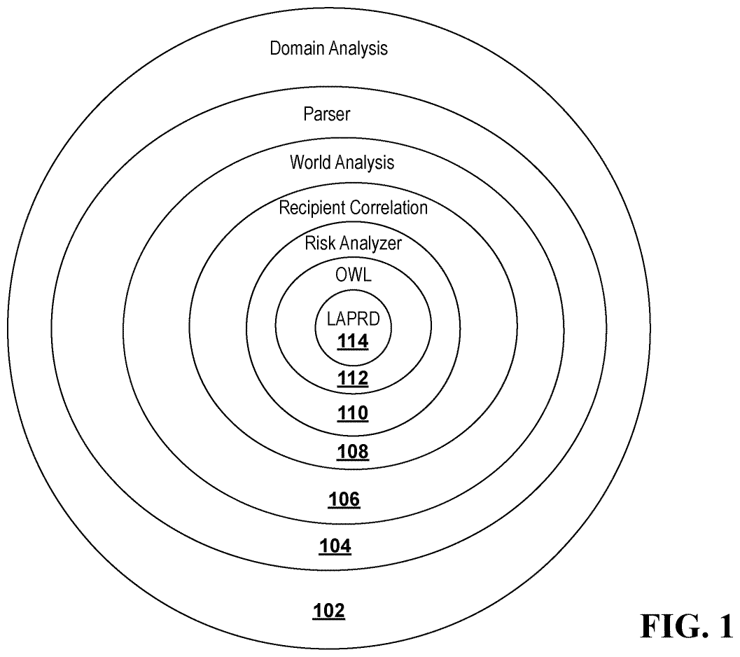

Turning to FIG. 1, a schematic diagram of example risk analysis modules, or “layers,” is shown. As used herein, the terms “module” and “layer” refer to functional components configured to perform one or more designated operations. A module or layer may be implemented in hardware, software, firmware, or any combination thereof, and may be executed by one or more processors. Modules or layers need not be physically distinct or separately instantiated components and may share computational resources. In some embodiments, two or more modules may be combined, or a single module may be distributed across multiple processing units.

A communication, such as an outgoing enterprise communication (for example, an email transmitted from an enterprise to an external recipient), is analyzed sequentially by a domain analysis layer 102, a parser layer 104, a word analysis layer 106, a recipient correlation layer 108, a risk analyzer layer 110, and a vector database layer 112 (“OWL” layer 112). Depending on the analysis performed by vector database layer 112, the communication may be further analyzed by a content analysis layer 114 (“LAPRD” layer 112).

Domain analysis layer 102 is configured to identify, by processing metadata associated with the communication (which, for the purposes of the following discussion, is considered to be an email), whether the outgoing email is addressed to a personal domain or a business domain (i.e., the domain associated with the enterprise from which the email is being sent). If domain analysis layer 102 identifies that the email is addressed to a personal account or a business account not associated with the enterprise, then analysis passes to parser layer 104. If domain analysis layer 102 identifies that the email is addressed to an account associated with the enterprise, then the email may be identified as not risky. When performing domain analysis, domain analysis layer 102 may determine whether the email is being copied (i.e., “cc'd”) to a personal account or to a business account not associated with the enterprise, such as a competitor's business account.

Parser layer 104 is configured to remove signatures, headers, and footers from the email to prepare the outgoing email for content analysis. Furthermore, signatures are analyzed for risk identification. Signature analysis may include detecting anomalous or high-risk content embedded within signature fields, such as portions of copied or forwarded confidential communications. For example, the system may identify instances in which sensitive internal email content has been copied into a signature block and is being transmitted to an external recipient. The analysis then proceeds to word analysis layer 106.

Word analysis layer 106 is configured to analyze the subject and body of the email for obvious risk identifiers, such as personal identification information and the presence of one or more pre-defined keywords. The analysis then proceeds to recipient correlation layer 108.

Recipient correlation layer 108 is configured to analyze the relationship between the sender and the recipient(s). For example, recipient correlation layer 108 may determine whether the email is being addressed to a relative of the sender who is known to work for a competitor of the enterprise from which the email is being sent. The analysis then proceeds to risk analyzer layer 110.

Risk analyzer layer 110 is configured to generate a risk profile for the email based on the outputs of the previous layers that analyzed the email. For example, risk analyzer layer 110 may consider the email to be high-risk if there is an identified relationship between the sender and a competitor to whom the email is being addressed. Risk analyzer layer 110 may consider additional factors when generating the risk profile. Additional factors that may influence the risk profile include, for example, the total number of emails sent by the sender, the frequency with which the sender sends emails, the type of any attachments included in the email, the number of attachments, and the size of the attachments. Once the risk profile has been generated, the analysis then proceeds to vector database layer 112.

Vector database layer 112 compares the risk profile to stored risk profiles generated for other outgoing emails considered to have met a minimum risk threshold or to otherwise have been identified as risky. For example, if a similarity score exceeds a defined threshold, the outgoing email may be identified as risky. The use of vector database layer 112 is generally computationally expensive, and therefore vector database layer 112 is used in cases where the determined risk profile of the email indicates that the email is high-risk or has an ambiguous degree of risk (for example, if the metadata analysis was unable to confirm that the email is not high-risk). The operation of vector database layer 112 is described in further detail in co-pending US patent application publication no. US 2026/0025396, filed on Jul. 17, 2025, entitled SYSTEMS AND METHODS FOR DETECTING INSIDER THREATS, and hereby incorporated by reference in its entirety.

If vector database layer 112 determines, based on the analysis of the risk profile, that further risk analysis is needed, then the content of the email is analyzed using content analysis layer 114, as described in further detail below. Even if the risk profile of the email does not correspond to any stored risk profiles, vector database layer 112 may nevertheless consider an email to warrant further analysis. This decision may be based, for example, on the analysis carried out in the previous layers.

As described in further detail below, content analysis layer 114 employs one or more prompts and one or more trained language models (such as SLMs) to perform machine learning-based analysis of the email's content and its associated attachments. The analysis performed by content analysis layer 114 is generally the most computationally expensive out of all the layers, and therefore content analysis layer 114 is generally only invoked if vector database layer 112 determines, based on its comparison of the email's risk profile to stored risk profiles, that the email is high-risk or otherwise of a sufficiently ambiguous risk to merit content analysis.

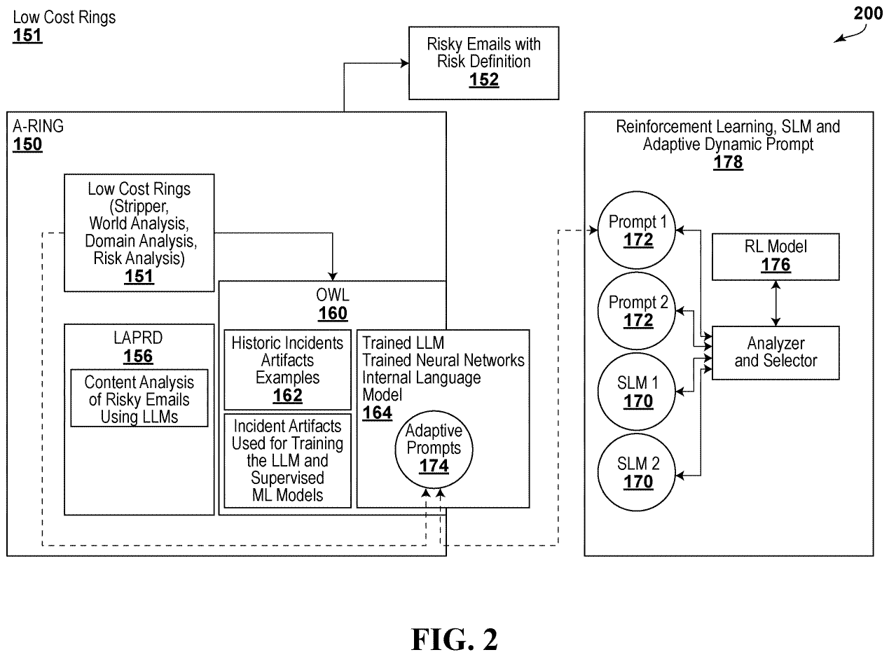

Turning to FIG. 2, there is shown a diagram of a system 200 for determining an overall risk associated with a communication, according to an embodiment of the disclosure

Generally, system 200 comprises a first module 150 that acts as a varying cost classifier configured to identify an overall risk associated with a communication (e.g., an email). As part of this identification process, module 150 may use one or more trained language models 164 (such as SLMs) that are configured to analyze the content (including any attachments) of the email. The specific prompts 174 and/or the specific trained language models 164 used to perform the content analysis, may be selected from respective pools of prompts 172 and trained language models 170 based on an identified risk associated with the email. The identified risk may be determined based on metadata analysis (performed by domain analysis layer 102, parser/stripper layer 104, word analysis layer 106, recipient correlation layer 108, and risk analyzer layer 110, as described above) and/or based on the similarity of a risk profile generated for the email to stored risk profiles generated for past emails that were identified as high-risk. System 200 includes a second module 178 which comprises a reinforcement learning engine 176 that is used to identify, from among the respective pools 172, 170 of prompts and trained language models, which prompt(s) and which trained language model(s) to use when analyzing the content of an email.

As can also be seen in FIG. 2, module 150 includes a layered configuration 151 of “low-cost” risk analysis modules or layers (in particular, domain analysis layer 102, parser/stripper layer 104, word analysis layer 106, recipient correlation layer 108, and risk analyzer layer 110), as described in connection with FIG. 1. As also described above, the output of risk analyzer layer 110 is a generated risk profile based on the analysis performed by the other layers in layered configuration 151. The risk profile is passed to vector database module 160 (“OWL” module 160), which, as described above, compares the risk profile to stored risk profiles 162 relating to examples of emails that have been classified as high-risk. If vector database module 160 determines that further risk analysis is needed, one or more prompts 174 and one or more trained language models 164 are then used by content analysis module 156 (“LAPRD” module 156) to perform content analysis on the email and its attachments.

As described above, the specific prompt(s) 172 and SLM(s) 170 that are selected to perform the content analysis are identified using reinforcement learning (RL) engine 176. In particular, RL engine 176 is used to select the most appropriate prompt/SLM in a given situation and context. This is because different prompts, depending on the specific context, may result in the SLM generating different outputs. According to some embodiments, multiple different prompts may be used, as well as multiple different SLMs. RL engine 176 may therefore adaptively learn which prompt(s) and which SLM(s) are most suited to the particular content analysis that is required.

Prompts may be developed and categorized on the basis of specific content to be analyzed (such as whether the content relates to financial data in a spreadsheet, a screenshot of internal company processes, or computer code), and the choice of prompts is adaptive in nature to the type of detected risk. For example, prompts and SLMs may be selected based on the type of attachments included in the email, as well as other features of the risk profile associated with the email. For example, a specific set of prompts and a specific SLM (or a specific set of SLMs) may be selected if the email includes one or more PDF attachments, while a different set of prompts and a different SLM (or a different set of SLMs) may be selected if the email includes one or more images as attachments. As another example, images, audio, video, and financial data in attachments may each be analyzed using different SLMs. Furthermore, spreadsheets (such as Excel attachments) may be scanned for personally identifiable information (PII) data, while PDFs may be scanned for process flow diagrams.

If content analysis module 156 determines, based on the content analysis, that the email is high-risk (152), then transmission of the email may be prevented, and the email may undergo further investigation (for example, by a human operator). For example, content analysis module 156 may use one or more prompts to generate risk-specific questions for evaluation by the selected SLM(s), and may analyze the corresponding outputs generated by the SLM(s) to determine one or more risk levels.

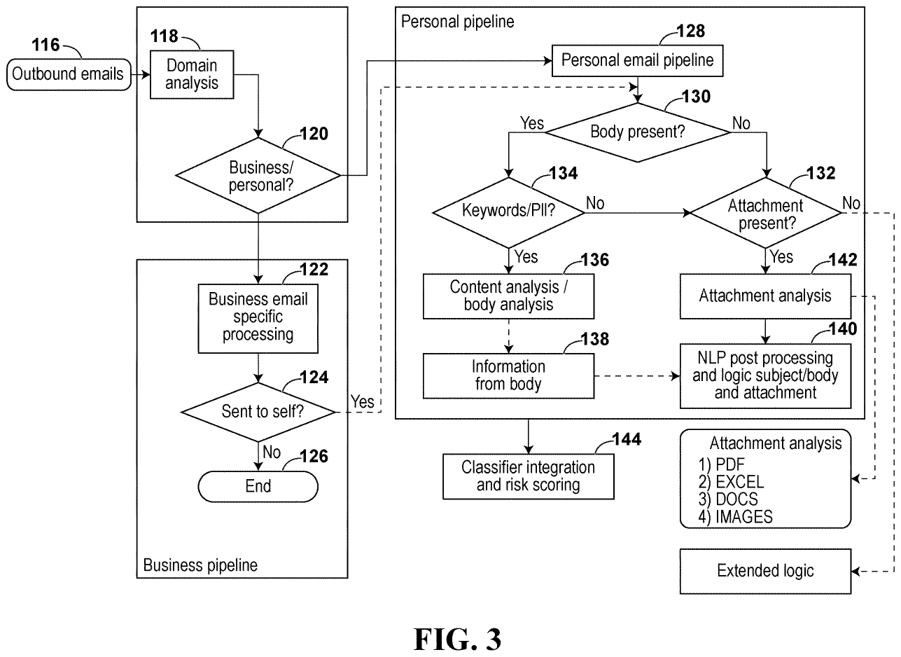

Turning to FIG. 3, there is shown a schematic flow diagram of a method of determining an overall risk associated with a communication, according to an embodiment of the disclosure. Some of the processing blocks of FIG. 3 correspond to some of the risk analysis layers described in connection with FIG. 1. In particular, domain analysis layer 102 corresponds to block 118, parser layer 104 corresponds to block 128, and word analysis layer 106 corresponds to block 134. Recipient correlation layer 108 corresponds to blocks 122 and 124. Risk analyzer layer 110 corresponds to the collective outcomes of blocks 130, 132, and 134. Content analysis layer 114 (LAPRD module) corresponds to blocks 140 and 142.

At block 116 outbound emails are detected. At block 118, domain analysis is performed by domain analysis layer 102.

At block 120, it is determined whether the email is associated with a business pipeline or a personal pipeline. In particular, based on one or more domains identified in metadata associated with the email, the system determines whether the email is addressed to an account associated with the enterprise (business) or to a personal or external third-party account.

If the email is associated with the business pipeline, processing proceeds to block 122, where business-email-specific processing is performed. At block 124, it is determined whether the email was sent to the sender's own account (“sent to self”). If the email is not sent to the sender, processing ends at block 126. If the email is sent to the sender, processing proceeds to block 130 of the personal pipeline for further evaluation.

If, at block 120, the email is determined to be associated with the personal pipeline, processing proceeds to block 128. At block 130, it is determined whether a body is present in the email.

If a body is present, then at block 134 it is determined whether one or more keywords or items of personally identifiable information (PII) are present in the body. If such keywords or PII are detected, the body is analyzed at block 136 using content analysis layer 114. At block 138, information extracted from the body is generated and provided to block 140 for NLP post-processing and logical analysis of the subject, body, and any attachments.

If no keywords or PII are detected at block 134, processing proceeds to block 132 to determine whether one or more attachments are present.

If no body is present at block 130, processing similarly proceeds to block 132, where it is determined whether the email includes one or more attachments.

If one or more attachments are present, attachment analysis is performed at block 142. The attachments may include, for example, PDF files, Excel files, documents, or images. Following attachment analysis, NLP post-processing and logical analysis of the subject, body, and attachments are performed at block 140.

Outputs from attachment analysis (block 142) and/or post-processing (block 140) are provided to a classifier integration and risk scoring stage 144, where overall risk scoring is performed.

If one or more attachments are not present, the communication may be processed using one or more classification and risk scoring models to determine the overall risk associated with the communication (at block “Extended logic”). Such models may comprise machine learning models configured to evaluate available features of the communication and generate a risk score or classification.

Embodiments of the disclosure are therefore directed at methods of determining an overall risk associated with a communication, as well as methods of training a reinforcement learning engine to identify prompts and trained language models to be used in content analysis of communications such as emails and their attachments. Embodiments of the disclosure are further directed at systems configured to train reinforcement learning engines for such a purpose, as well as computer-readable media storing reinforcement learning engines trained in such a manner. Embodiments of the disclosure are further directed to the use of reinforcement learning engines trained in such a manner.

The present technology may be embodied within a system, a method, a computer program product or any combination thereof. The computer program product may include a computer-readable storage medium or media having computer-readable program instructions thereon for causing a processor to carry out aspects of the present technology. The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present technology may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language or a conventional procedural programming language. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by using state information of the computer-readable program instructions to personalize the electronic circuitry, in order to implement aspects of the present technology.

Aspects of the present technology have been described above with reference to flowchart illustrations and/or block diagrams of methods, apparatus (systems) and computer program products according to various embodiments. In this regard, the flowchart and block diagrams in the drawings illustrate the architecture, functionality, and operation of possible implementations of systems, methods and computer program products according to various embodiments of the present technology. For instance, each block in the flowchart or block diagrams may represent a module, segment, or portion of instructions, which comprises one or more executable instructions for implementing the specified logical function(s). It should also be noted that, in some alternative implementations, the functions noted in the block may occur out of the order noted in the drawings. For example, two blocks shown in succession may, in fact, be executed substantially concurrently, or the blocks may sometimes be executed in the reverse order, depending upon the functionality involved. Some specific examples of the foregoing may have been noted above but any such noted examples are not necessarily the only such examples. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer-readable program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer-readable program instructions may also be stored in a computer-readable storage medium that can direct a computer, other programmable data processing apparatus, or other devices to function in a particular manner, such that the instructions stored in the computer-readable storage medium produce an article of manufacture including instructions which implement aspects of the functions/acts specified in the flowchart and/or block diagram block or blocks. The computer-readable program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

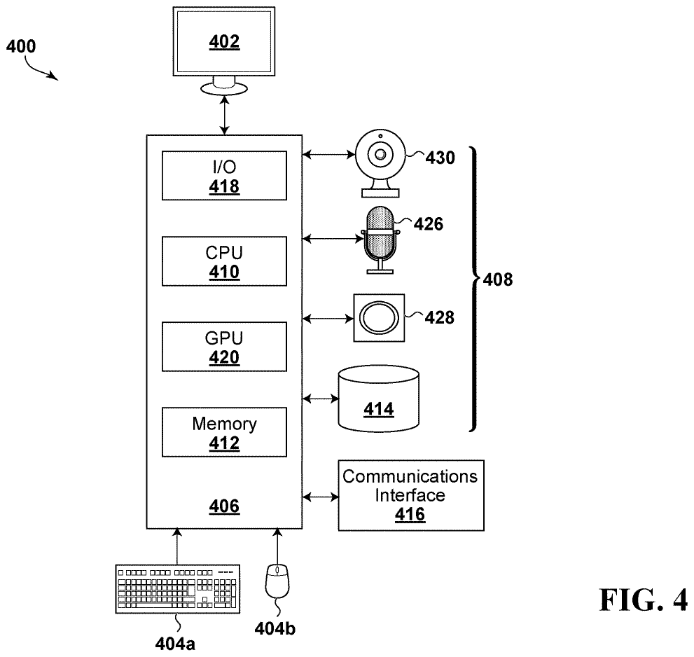

An illustrative computer system in respect of which the technology herein described may be implemented is presented as a block diagram in FIG. 4. The illustrative computer system is denoted generally by reference numeral 400 and includes a display 402, input devices in the form of keyboard 404a and pointing device 404b, computer 406 and external devices 408. While pointing device 404b is depicted as a mouse, it will be appreciated that other types of pointing device, or a touch screen, may also be used.

The computer 406 may contain one or more processors or microprocessors, such as a central processing unit (CPU) 410. The CPU 410 performs arithmetic calculations and control functions to execute software stored in an internal memory 412, preferably random-access memory (RAM) and/or read only memory (ROM), and possibly additional memory 414. The additional memory 414 may include, for example, mass memory storage, hard disk drives, optical disk drives (including CD and DVD drives), magnetic disk drives, magnetic tape drives (including LTO, DLT, DAT and DCC), flash drives, program cartridges and cartridge interfaces such as those found in video game devices, removable memory chips such as EPROM or PROM, emerging storage media, such as holographic storage, or similar storage media as known in the art. This additional memory 414 may be physically internal to the computer 406, or external as shown in FIG. 4, or both.

The computer system 400 may also include other similar means for allowing computer programs or other instructions to be loaded. Such means can include, for example, a communications interface 416 which allows software and data to be transferred between the computer system 400 and external systems and networks. Examples of communications interface 416 can include a modem, a network interface such as an Ethernet card, a wireless communication interface, or a serial or parallel communications port. Software and data transferred via communications interface 416 are in the form of signals which can be electronic, acoustic, electromagnetic, optical or other signals capable of being received by communications interface 416. Multiple interfaces, of course, can be provided on a single computer system 400.

Input and output to and from the computer 406 is administered by the input/output (I/O) interface 418. This I/O interface 418 administers control of the display 402, keyboard 404a, external devices 408 and other such components of the computer system 400. The computer 406 also includes a graphical processing unit (GPU) 420. The latter may also be used for computational purposes as an adjunct to, or instead of, the (CPU) 410, for mathematical calculations.

The external devices 408 include a microphone 426, a speaker 428 and a camera 430. Although shown as external devices, they may alternatively be built in as part of the hardware of the computer system 400.

The various components of the computer system 400 are coupled to one another either directly or by coupling to suitable buses.

The term “computer system”, “data processing system” and related terms, as used herein, is not limited to any particular type of computer system and encompasses servers, desktop computers, laptop computers, networked mobile wireless telecommunication computing devices such as smartphones, tablet computers, as well as other types of computer systems.

Thus, computer-readable program code for implementing aspects of the technology described herein may be contained or stored in the memory 412 of the computer 406, or on a computer usable or computer-readable medium external to the computer 406, or on any combination thereof.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

The terms “coupled”, “coupling” or “connected” as used herein can have several different meanings depending on the context in which these terms are used. For example, as used herein, the terms coupled, coupling, or connected can indicate that two elements or devices are directly connected to one another or connected to one another through one or more intermediate elements or devices depending on the particular context.

The term “and/or” herein when used in association with a list of items means any one or more of the items comprising that list.

As used herein, a reference to “about” or “approximately” a number or to being “substantially” equal to a number means being within +/−10% of that number.

Use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

While the disclosure has been described in connection with specific embodiments, it is to be understood that the disclosure is not limited to these embodiments, and that alterations, modifications, and variations of these embodiments may be carried out by the skilled person without departing from the scope of the disclosure.

It is furthermore contemplated that any part of any aspect or embodiment discussed in this specification can be implemented or combined with any part of any other aspect or embodiment discussed in this specification.

1. A method of determining an overall risk associated with a communication, comprising using one or more processors to:
perform a first risk analysis, comprising:
analyzing metadata associated with the communication; and
based on the analyzed metadata, determining a risk profile of the communication;
perform a second risk analysis, comprising:
comparing the risk profile to one or more stored risk profiles; and
based on the comparison, determining that a third risk analysis is required; and
perform the third risk analysis, comprising:
analyzing a content of the communication to determine the overall risk associated with the communication.

2. The method of claim 1, wherein:
analyzing the metadata comprises analyzing a domain associated with the communication; and
determining the risk profile of the communication is based on the analyzed domain.

3. The method of claim 1, wherein:
analyzing the metadata comprises analyzing a signature associated with the communication; and
determining the risk profile of the communication is based on the analyzed signature.

4. The method of claim 1, wherein:
analyzing the metadata comprises analyzing one or both of a subject and a body of the communication; and
determining the risk profile of the communication is based on one or both of the analyzed subject and the analyzed body.

5. The method of claim 1, wherein:
analyzing the metadata comprises:
identifying, based on the metadata, a sender of the communication and an intended recipient of the communication; and
analyzing a relationship between the sender and the intended recipient; and
determining the risk profile of the communication is based on the analyzed relationship.

6. The method of claim 1, wherein:
analyzing the metadata comprises:
analyzing a domain associated with the communication;
analyzing a signature associated with the communication;
analyzing one or both of a subject and a body of the communication;
identifying, based on the metadata, a sender of the communication and an intended recipient of the communication; and
analyzing a relationship between the sender and the intended recipient; and
determining the risk profile of the communication is based on the analyzed domain, the analyzed signature, one or both of the analyzed subject and the analyzed body, and the analyzed relationship.

7. The method of claim 1, wherein the one or more stored risk profiles are associated with one or more high-risk communications.

8. The method of claim 1, wherein comparing the risk profile to the one or more stored risk profiles comprises:
converting the risk profile into one or more feature vectors; and
comparing the one or more feature vectors to one or more stored feature vectors associated with the one or more stored risk profiles.

9. The method of claim 1, wherein analyzing the content comprises:
inputting the content to a trained machine learning model; and
using the trained machine learning model to generate, based on the inputted content, an indication of the overall risk associated with the communication.

10. The method of claim 9, wherein inputting the content comprises:
selecting, based on the communication, the trained machine learning model from a pool of trained machine learning models; and
inputting the content to the selected trained machine learning model.

11. The method of claim 10, wherein selecting the trained machine learning model comprises:
selecting the trained machine learning model based on one or both of an identified risk and one or more attachments associated with the communication.

12. The method of claim 9, wherein analyzing the content further comprises:
further inputting one or more prompts to the trained machine learning model; and
using the trained machine learning model to generate, based on the inputted content and the one or more prompts, an indication of the overall risk associated with the communication.

13. The method of claim 12, wherein inputting the one or more prompts comprises:
selecting, based on the communication, the one or more prompts from a pool of prompts; and
inputting the selected one or more prompts to the trained machine learning model.

14. The method of claim 13, wherein selecting the one or more prompts comprises:
selecting the one or more prompts based on one or both of an identified risk and one or more attachments associated with the communication.

15. The method of claim 9, wherein the trained machine learning model is a trained small language machine learning model.

16. The method of claim 9, further comprising:
comparing the overall risk to a predetermined threshold; and
based on the comparison, adjusting one or both of:
a pool of prompts for use with the trained machine learning mode; and
a pool of trained machine learning models for performing content analysis of communications.

17. The method of claim 1, further comprising:
determining, based on the overall risk, that the communication is a high-risk communication; and
preventing the high-risk communication from being transmitted.

18. A non-transitory, computer-readable medium storing computer program code configured, when executed by one or more processors, to cause the one or more processors to perform a method of determining an overall risk associated with a communication, comprising:
performing a first risk analysis, comprising:
analyzing metadata associated with the communication; and
based on the analyzed metadata, determining a risk profile of the communication;
if the risk profile satisfies one or more predefined criteria, performing a second risk analysis, comprising:
comparing the risk profile to one or more stored risk profiles; and
based on the comparison, determining whether a third risk analysis is required; and
if the third risk analysis is required, performing the third risk analysis, comprising:
analyzing a content of the communication to determine the overall risk associated with the communication.

19. A method of determining an overall risk associated with a communication, comprising using one or more processors to:
perform a first risk analysis, comprising:
analyzing metadata associated with the communication; and
based on the analyzed metadata, determining that second risk analysis is required; and
performing the second risk analysis, comprising:
inputting a content of the communication to a trained machine learning model; and
using the trained machine learning model to generate, based on the inputted content, an indication of the overall risk associated with the communication.
